(19) United States
(12) Patent Application Publication
(10) Pub. No.: US 2026/0120932 A1
(43) Pub. Date: Apr. 30, 2026

(54) INDUCTOR WITH MULTIPLE LAYERS

(71) Applicant: TEXAS INSTRUMENTS INCORPORATED, Dallas, TX (US)

(72) Inventors: Radhika Juluri, Bangalore (IN); Debapriya Sahu, Bangalore (IN); Srinivas Veeramreddi, Bengaluru (IN)

(21) Appl. No.: 18/929,819

(22) Filed: Oct. 29, 2024

(51) Int. Cl. H01F 17/00; H01F 17/02

(52) U.S. Cl. CPC H01F 17/0013; H01F 17/02; H01F 2017/0026; H01F 2017/004

(57) ABSTRACT

A coil structure including a first conductive layer with a first conductive loop segment and a second conductive loop segment that surround a central axis that is orthogonal to the first conductive layer. The first and second conductive loop segments are arranged symmetrically on opposite sides of a plane of the central axis. A second conductive layer includes a third conductive loop segment that surrounds the central axis. A third conductive layer includes a fourth conductive loop segment and a fifth conductive loop segment that surround the central axis. The fourth and fifth conductive loop segments are arranged symmetrically on opposite sides of the plane. The second conductive layer is disposed between the first and third conductive layers. A first connecting structure connects the first conductive loop segment to the fifth conductive loop segment. A second connecting structure connects the fourth conductive loop segment to the third conductive loop segment.

### TECHNICAL FIELD

The present disclosure relates generally to an electronic system, and, in particular embodiments, to an inductor with multiple layers.

### BACKGROUND

Inductors are common components in the field of radio frequency (RF) circuits. In some cases, inductors are implemented with multiple stacked conductive layers.

### SUMMARY

In accordance to an embodiment, a coil structure includes: a first conductive layer including a first conductive loop segment and a second conductive loop segment that collectively substantially surround a central axis that is orthogonal to the first conductive layer, the first and second conductive loop segments being arranged symmetrically on opposite sides of a plane that includes the central axis; a second conductive layer, the second conductive layer including a third conductive loop segment that substantially surrounds the central axis when viewed along the central axis; a third conductive layer, the third conductive layer including a fourth conductive loop segment and a fifth conductive loop segment that collectively substantially surround the central axis when viewed along the central axis, the fourth and fifth conductive loop segments being arranged symmetrically on opposite sides of the plane, where the second conductive layer is disposed between the first and third conductive layers; a first connecting structure connecting the first conductive loop segment of the first conductive layer to the fifth conductive loop segment of the third conductive layer; and a second connecting structure connecting the fourth conductive loop segment of the third conductive layer to the third conductive loop segment of the second conductive layer.

In accordance to an embodiment, an inductive structure includes: a first conductive layer including a first conductive trace and a second conductive trace; a second conductive layer disposed, the second conductive layer including a third conductive trace; a third conductive layer disposed, the third conductive layer including a fourth conductive trace and a fifth conductive trace, where the second conductive layer is disposed between the first and third conductive layers; a first via connecting a first end of the first conductive trace to a first end of the fifth conductive trace; a second via connecting a first end of the fourth conductive trace to a first end of the third conductive trace; a third via connecting a first end of the second conductive trace to a second end of the fourth conductive trace; and a fourth via connecting a second end of the fifth conductive trace to a second end of the third conductive trace.

In accordance to an embodiment, an integrated circuit includes: a substrate, where an inductor axis perpendicularly intersects an upper surface of the substrate; a first metal trace arranged at a first height over the substrate and extending axially about a first side of the inductor axis; a second metal trace arranged at the first height over the substrate and extending axially about a second side of the inductor axis, the second side of the inductor axis opposite the first side; a third metal trace arranged at a second height over the substrate, the third metal trace extending axially about the first and second sides of the inductor axis directly over at least a portion of the first and second metal traces; a fourth metal trace arranged at a third height over the substrate, the fourth metal trace extending axially about the first side of the inductor axis and extending directly over a first portion of the third metal trace; a fifth metal trace arranged at the third height over the substrate, the fifth metal trace extending axially about the second side of the inductor axis and extending directly over a second portion of the third metal trace; a first via connecting a first end of the first metal trace to a first end of the fifth metal trace; a second via connecting a first end of the fourth metal trace to a first end of the third metal trace; a third via connecting a first end of the second metal trace to a second end of the fourth metal trace; and a fourth via connecting a second end of the fifth metal trace to a second end of the third metal trace.

In accordance to an embodiment, a coil structure includes: a first conductive layer including a first conductive trace and a second conductive trace; a second conductive layer disposed over the first conductive layer, the second conductive layer including a third conductive trace and a fourth conductive trace; a third conductive layer disposed over the second conductive layer, the third conductive layer including a fifth conductive trace; a first via connecting a first end of the first conductive trace to a first end of the fifth conductive trace; a second via connecting a first end of the third conductive trace to a first end of the fourth conductive trace; a third via connecting a first end of the second conductive trace to a second end of the fourth conductive trace; and a fourth via connecting a second end of the fifth conductive trace to a second end of the third conductive trace.

### BRIEF DESCRIPTION OF THE DRAWINGS

For a more complete understanding of the present disclosure, and the advantages thereof, reference is now made to the following descriptions taken in conjunction with the accompanying drawings, in which:

FIGS. 1, 2A, 2B, 2C, and 3 are schematics illustrating example views of a coil structure with multiple layers where a first layer of the coil structure directly connects to the third layer of the coil structure thereby skipping a direct connection to the second layer of the coil structure;

FIG. 4 is a cross-sectional view of the coil structure of FIGS. 1-3;

FIG. 5 is a circuit diagram of the coil structure of FIGS. 1-4;

FIGS. 6, 7A, 7B, and 7C are schematics illustrating example views of a coil structure with multiple layers where a first layer directly connects to the second layer, and the second layer directly connects to the third layer;

FIG. 8 is a cross-sectional view of the coil structure of FIGS. 6 and 7C;

FIG. 9 is a circuit diagram of the coil structure of FIGS. 6-8;

FIGS. 10A, 10B, and 11 show a multi-layer coil structure as a balun or a transformer; and

FIGS. 12-13 show cross-sectional views of multi-layer coil structures that have at least four layers.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Some embodiments relate to a low area inductor using multiple layers with improved self-resonant frequency (SRF).

Electronic applications may benefit from inductors with high self-resonant frequency (SRF) to mitigate cross-talk and improve circuit quality factor. The arrangement of conductive layers of an inductor can have an effect on the SRF as well as inductor size which can impact circuit density.

Inductors are common components in circuits, including radio frequency (RF) circuits, that provide frequency-selective and reactive properties for inductor-capacitor (LC) tank circuits, impedance matching, RF tuning, balun circuits, transformers, filters, chokes, oscillators, phase shifters, and other circuit configurations. Printed inductors (e.g., on chip inductors implemented on a silicon die with multiple metal layers or on a printed circuit board (PCB)) may provide benefits in RF circuits relative to discrete inductors. Printed inductors can be implemented on one or more conductive layers and may provide compact integration and/or monolithic integration with active components, may reduce parasitic effects, and may save cost relative to discrete inductors. However, printed inductors with multiple conductive layers may face challenges. Interlayer capacitance within conductive layers of the printed inductor can hinder the quality factor (Q) or lower the self-resonant frequency (SRF) of the inductors. Inductance values for printed inductors can be limited, as higher inductance may require more area on a chip or board which is prohibitive and can lead to electromagnetic interference (EMI) due to leakage of magnetic flux.

Various aspects described herein relate to a low area coil structure using multiple conductive layers. Techniques described herein provide an arrangement of conductive layers where segments of each layer efficiently utilize the inductor's footprint, which may advantageously maximize magnetic flux. For example, conductive traces from different layers of the coil structure may extend from an outer perimeter of the low area coil structure toward an inner region of the low area coil structure, crossing over each other to reach a corresponding interconnect to change layers. This configuration allows layer transitions to occur within the interior of the low area coil structure, while the majority of the conductive traces remain stacked along the outer perimeter, which may advantageously maximize inductance of the low area coil structure with a minimal footprint.

Techniques described herein may further provide an arrangement of conductive layers where parasitic capacitance between layers is minimized, which may advantageously maximize the inductors SRF and Q. For example, the low area coil structure may include three or more conductive layers, including a first, second, and third conductive layer. The second conductive layer is disposed between the first and third conductive layers. Traces of the first conductive layer are connected to traces of the third conductive layer and traces of the third conductive layer are connected to traces of the second conductive layer. As such, the presented low area coil structure exhibits a zig-zag geometry in the layer stack. The layer skipping configuration of the first conductive layer to the third conductive layer (rather than first conductive layer to the second conductive layer) may advantageously minimize parasitic effects of self-capacitance between layers of the low area coil structure, which may advantageously improve SRF.

Aspects described herein can result in up to a 50% or better reduction in inductor footprint compared to other arrangements. Considering some radio integrated circuits (ICs) can allocate 20%-30% of their space to inductors, the structures described herein can advantageously save substantial die cost without degrading performance.

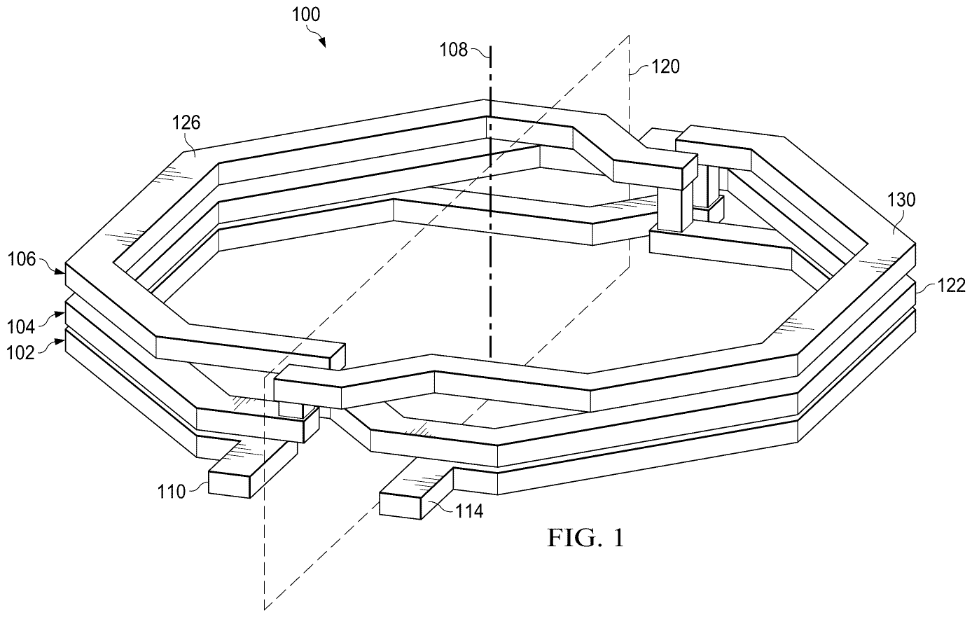

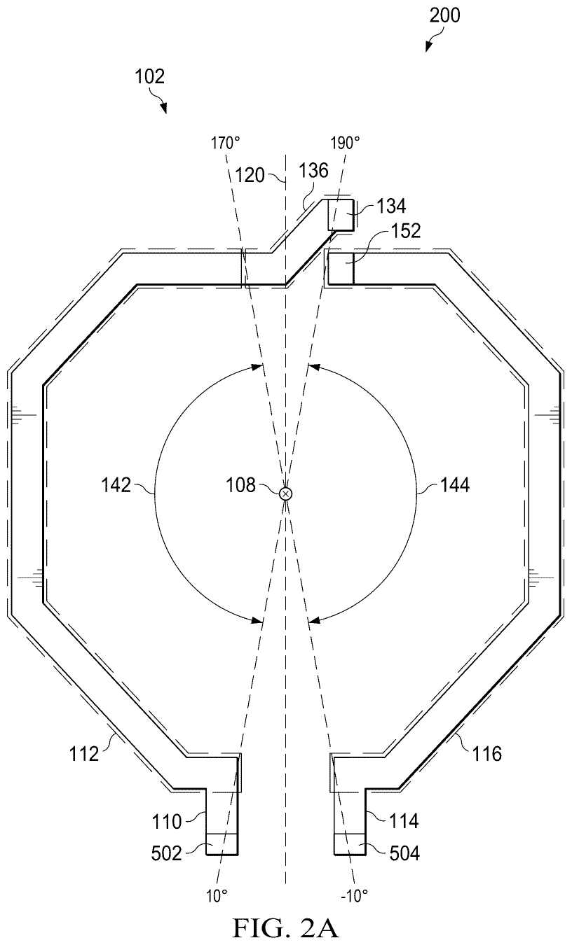

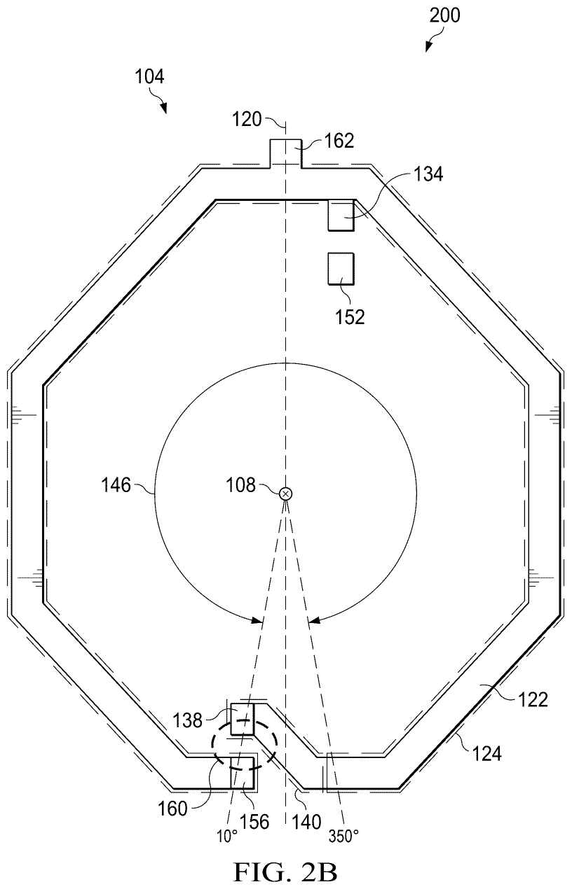

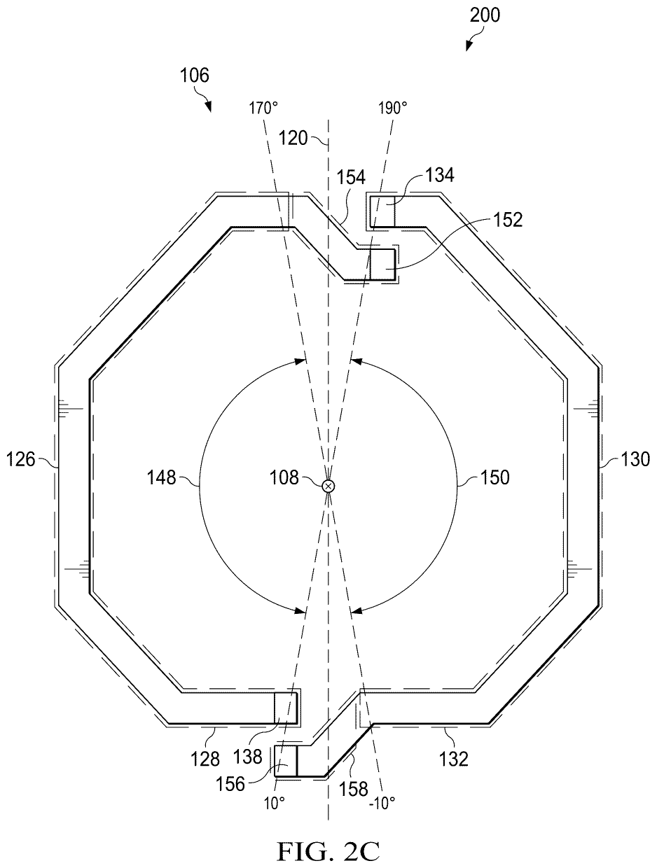

FIG. 1 shows a three-dimensional view of coil structure 100 (e.g., low area coil structure). FIG. 2A shows a two-dimensional view of the first conductive layer 102 of the coil structure 100. FIG. 2B shows a two-dimensional view of the second conductive layer 104 of the coil structure 100. FIG. 2B shows a two-dimensional view of the third conductive layer 106 of the coil structure 100. Accordingly, the first, second, and third conductive layers 102, 104, 106, can be referred to herein as layers 200. FIGS. 1, 2A, 2B, and 2C are now referred to concurrently.

The coil structure 100 (referred to also as an inductive structure, an inductor, or a circuit component) has three layers, a first conductive layer 102, a second conductive layer 104, and a third conductive layer 106. The second conductive layer 104 is disposed between the first conductive layer 102 and the third conductive layer 106. In some examples, the first, second, and third conductive layers 102, 104, 106 of the layers 200 can be referred to as a first metal layer, a second metal layer, and a third metal layer respectively, or as a first layer, a second layer, and a third layer respectively. The coil structure 100 has a central axis 108 (also referred to as an inductor axis) that is orthogonal to the layers 200.

The first conductive layer 102 has a first conductive trace 110 with a first conductive loop segment 112. The first conductive layer 102 further has a second conductive trace 114 with a second conductive loop segment 116. The first conductive loop segment 112 and the second conductive loop segment 116 collectively substantially surround the central axis 108 where the first and second conductive loop segments 112, 116 are arranged symmetrically on opposite sides of a plane 120 that includes the central axis 108. When viewed from the central axis 108 and in a polar coordinate system, the first conductive loop segment 112 extends continuously over a first angle 142 ranging from approximately a first value of, e.g., −10° to 10° to a second value of approximately, e.g., 170° to 190°. The second conductive loop segment 116 extends continuously over a second angle 144 ranging from a third value of approximately, e.g., 170° and 190° to a fourth value of approximately, e.g., −10° to 10°. Accordingly, the first conductive trace 110 extends axially about a first side of the central axis 108. The second conductive trace 114 extends axially about a second side of the central axis 108, where the second side of the central axis 108 is opposite the first side of the central axis 108.

The second conductive layer 104 has third conductive trace 122 with a third conductive loop segment 124. The third conductive trace 122 is shaped like a loop that is octagonal in shape, with an open end 160, and has a first half and a second half on opposing sides of the plane 120. At a location opposite of the open end 160 of the third conductive trace 122, a center tap 162 extends from the third conductive trace 122 along the plane 120 in a direction that is away from the open end 160. The third conductive loop segment 124 substantially surrounds the central axis 108 when viewed along the central axis 108. When viewed from the central axis 108 in the polar coordinate system, the third conductive loop segment 124 extends continuously over a third angle 146 ranging from approximately a fifth value of, e.g., 1° to 20° to a sixth value of approximately, e.g., 340° to 359° (e.g., FIG. 2B shows) 350°. Accordingly, the third conductive trace 122 extends axially about the first and second sides of the central axis 108 directly over at least a portion of the first and second conductive traces 110, 114.

The third conductive layer 106 has a fourth conductive trace 126 with a fourth conductive loop segment 128. The third conductive layer 106 further has a fifth conductive trace 130 with a fifth conductive loop segment 132. The fourth and fifth conductive loop segments 128, 132 collectively substantially surround the central axis 108 when viewed along the central axis 108. Furthermore, the fourth and fifth conductive loop segments 128, 132 are arranged symmetrically on opposite sides of the plane 120. When viewed from the central axis 108 and in a polar coordinate system, the fourth conductive loop segment 128 extends continuously over a fourth angle 148 ranging from approximately a seventh value of, e.g., −10° to 10° to an eighth value of approximately, e.g., 170° to 190°. The fifth conductive loop segment 132 extends continuously over a fifth angle 150 ranging from a ninth value of approximately, e.g., 170° and 190° to a tenth value of approximately, e.g., −10° to 10°. Accordingly, the fourth conductive trace 126 extends axially about the first side of the central axis 108 and extends directly over a first portion of the third conductive trace 122. The fifth conductive trace 130 extends axially about the second side of the central axis 108 and extends directly over a second portion of the third conductive trace 122.

The layers 200 of the coil structure 100 are connected such that the first conductive layer 102 is connected to the third conductive layer 106 and the third conductive layer 106 is connected to the second conductive layer 104. As such, the first conductive layer 102 skips a direct connection to the second conductive layer 104, but is rather conductively connected to the second conductive layer 104 through the third conductive layer 106. Specifically, a first via 134 connects a first end of the first conductive trace 110 to a first end of the fifth conductive trace 130. As such, the first conductive trace 110 includes a first connecting structure 136 that connects the first conductive loop segment 112 to the fifth conductive loop segment 132. Accordingly, the first connecting structure 136 extends from the first conductive loop segment 112 on the first conductive layer 102 and includes the first via 134 that extends from the first conductive layer 102, through the second conductive layer 104, and to the third conductive layer 106 to couple to the fifth conductive loop segment 132. The first connecting structure 136 includes a first connecting segment that extends at an acute angle from a first end of the first conductive loop segment 112 and extends across the plane 120. Thus, the first connecting segment of the first connecting structure 136 is asymmetric about the plane 120.

A second via 138 connects a first end of the fourth conductive trace 126 to a first end of the third conductive trace 122. As such, the third conductive trace 122 includes a second connecting structure 140 that connects the third conductive loop segment 124 to the fourth conductive loop segment 128. Accordingly, the second connecting structure 140 extends from the third conductive loop segment 124 on the second conductive layer 104 and includes the second via 138 that extends from the second conductive layer 104 to the third conductive layer 106 to meet the fourth conductive loop segment 128. The second connecting structure 140 includes a second connecting segment that extends at an acute angle from a first end of the third conductive loop segment 124 and extends across the plane 120. Thus the second connecting segment of the second connecting structure 140 is asymmetric about the plane 120.

A third via 152 connects a first end of the second conductive trace 114 to a second end of the fourth conductive trace 126. As such, the fourth conductive trace 126 includes a third connecting structure 154 that connects the fourth conductive loop segment 128 to the second conductive loop segment 116. Accordingly, the third connecting structure 154 extends from the fourth conductive loop segment 128 on the third conductive layer 106 and includes the third via 152 that extends from the first conductive layer 102 to the third conductive layer 106 to meet the second conductive loop segment 116. The third connecting structure 154 includes a third connecting segment that extends at an acute angle from a first end of the fourth conductive loop segment 128 and extends across the plane 120. Thus the third connecting segment of the third connecting structure 154 is asymmetric about the plane 120.

A fourth via 156 connects a second end of the fifth conductive trace 130 to a second end of the third conductive trace 122. As such, the fifth conductive trace 130 includes a fourth connecting structure 158 that connects the fifth conductive loop segment 132 to the third conductive loop segment 124. Accordingly, the fourth connecting structure 158 extends from the fifth conductive loop segment 132 on the third conductive layer 106 and includes the fourth via 156 that extends from the second conductive layer 104 to the third conductive layer 106 to meet the third conductive loop segment 124. The fourth connecting structure 158 includes a fourth connecting segment that extends at an acute angle from a first end of the fifth conductive loop segment 132 and extends across the plane 120. Thus the fourth connecting segment of the fourth connecting structure 158 is asymmetric about the plane 120.

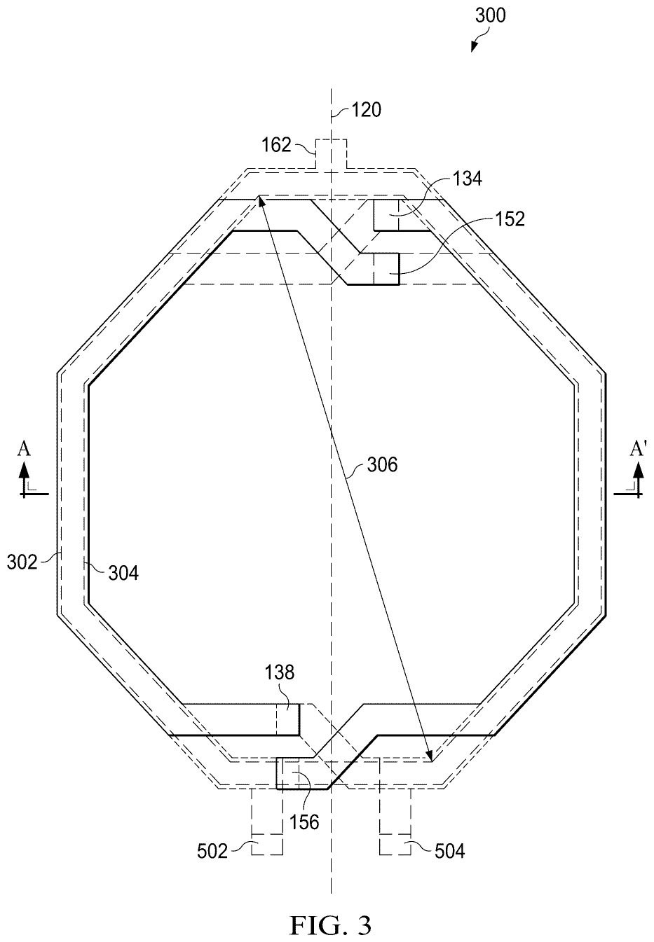

FIG. 3 shows a two-dimensional top-view 300 of the coil structure 100 with the layers 200 of FIGS. 2A, 2B, and 2C shown as a composite.

The two-dimensional top-view 300 shows the layers 200 of FIGS. 1, 2A, 2B, 2C and associated conductive features as they are stacked on one another. As seen in FIG. 3, an outer perimeter 302 of the coil structure 100 is defined by a composite of the first, second, third, fourth, and fifth conductive traces 110, 114, 122, 126, 130 (collectively referred to herein as “conductive traces”) that is coil shaped. The composite further defines an inner perimeter 304. As shown, the outer perimeter 302 and the inner perimeter 304 are octagonal in shape. In other embodiments (not shown), the outer perimeter 302 and the inner perimeter 304 can be other shapes (e.g., circular, oval, hexagons, or other polygonal shapes). The outer perimeter 302 coincides with an outer edge of the third conductive trace 122, and the inner perimeter 304 coincides with an inner edge of the third conductive trace 122. An area occupied within the inner perimeter 304 is referred to as an interior 306 (or an inner boundary) of the third conductive trace 122.

As seen in FIGS. 1-3, the second and fifth conductive traces 114, 130 substantially overlap and the first and fourth conductive traces 110, 126 substantially overlap. The first half of the third conductive trace 122 substantially overlaps with the first and fourth conductive traces 110, 126. The second half of the third conductive trace 122 substantially overlaps with the second and fifth conductive traces 114, 130. At a location opposite of the open end 160 of the third conductive trace 122, the first conductive trace 110 (e.g. the first connecting structure) extends into the interior 306 of the third conductive trace 122 and meets the first via 134 adjacent to the interior edge (e.g., the inner perimeter 304) of the third conductive trace 122. At the location opposite of the open end 160 of the third conductive trace, the fourth conductive trace 126 (e.g., the third connecting structure) extends into the interior 306 of the third conductive trace 122 and overlaps the first conductive trace 110 (e.g., the first connecting structure) to meet the third via 152. The third via 152 is located between the first via 134 and the open end 160 of the third conductive trace 122. Accordingly, at an axial location of the third conductive trace 122 that is opposite of the second and fourth vias 138, 156 the first via 134 separates the third via 152 from the inner edge of the third conductive trace 122. At an axial location of the third conductive trace 122 that is opposite of the first and third vias 134, 152, the fourth via 156 separates the second via 138 from the inner edge of the third conductive trace 122.

At the open end 160 of the third conductive trace 122, the second end of the third conductive trace 122 (e.g., the second connecting structure 140) extends to the interior 306 of the third conductive trace 122. The second end of the third conductive trace 122 is aligned adjacent to an inner edge of the first end of the third conductive trace 122. Accordingly, the second via 138 is disposed between the fourth via and the third via 152. Adjacent to the open end 160 of the third conductive trace 122, the fifth conductive trace 130 (e.g., the fourth connecting structure 158) overlaps the third conductive trace 122 (e.g., the second connecting structure 140) to meet the fourth via 156.

In some embodiments, the first, second, and third conductive layers 102, 104, 106 can be metal layers, and therefore can be referred to as a first, second, and third metal layers. Likewise, the first, second, third, fourth, and fifth conductive traces 110, 114, 122, 126, and 130 can be metal traces, and therefore can be referred to as a first, second, third, fourth, and fifth metal traces. The first, second, third, fourth, and fifth conductive loop segments 112, 116, 124, 128, 132 can be metal conductive loop segments and can be referred to as a first, second, third, fourth, and fifth metal loop segments, or broadly referred to as first, second, third, fourth, and fifth loop segments.

The first, second, and third conductive layers 102, 104, 106 can be or comprise copper, aluminum, silver, gold, nickel, tungsten, titanium, or the like. In some embodiments, the layers 200 comprise the same material (e.g., same metal or conductive material). In other embodiments, the first and second conductive layers 102, 104 comprise a first metal and the third conductive layer 106 comprises a second metal that is different from the first metal. For example, the first metal can be copper and the second metal can be aluminum. Using different metals for the layers 200 can provide the advantage of high electrical conductivity for buried layers (e.g., first and second conductive layers 102, 104) thereby reducing resistive losses, and the advantage of corrosion and oxidation resistance for the third conductive layer 106 that can be exposed to an atmosphere. Different metals for the layers 200 provides enhanced electrical performance and durability for the coil structure 100.

The second end of the first conductive trace 110 and the second end of the second conductive trace 114 are at opposing sides of the plane 120 and are the differential terminals of the coil structure 100. The second end of the first conductive trace 110 has a first differential terminal 502, and the second end of the second conductive trace 114 has a second differential terminal 504. A signal may be provided to the second end of the first and second conductive traces 110, 114 (e.g., an alternating current (AC) or direct current (DC) signal). The signal induces a magnetic field in the coil structure 100 (e.g., within the inner perimeter 304), where a differential current (from the signal) on the first and second conductive traces 110, 114 of the first conductive layer 102 generates a magnetic flux that couples with the second and third conductive layers 104, 106. As the differential current extends to the third conductive layer 106 from the first conductive layer 102, and from the third conductive layer 106 to the second conductive layer 104, the magnetic coupling between the layers 200 increases an overall inductance of the coil structure 100 by increasing the magnetic flux through the coil structure 100. The coil structure 100 has a predominantly symmetric footprint, where the first and second conductive loop segments 112, 116 are substantially symmetric about the plane 120, the third conductive loop segment 124 is substantially symmetric about the plane 120, and the fourth and fifth conductive loop segments 128, 132 are substantially symmetric about the plane 120. Minor asymmetry of the coil structure 100 comes from the first, second, third, and fourth connecting structures 136, 140, 154, 158 (collectively referred to as connecting structures). However, the connecting structures comprise a minority of the area of the coil structure 100. As the coil structure 100 is predominantly symmetric, in some embodiments, the magnetic field induced from the differential current is substantially balanced, accordingly, the magnetic field is substantially uniformly distributed through the coil structure 100. Accordingly, the coil structure 100 can advantageously realize favorable electromagnetic interference (EMI) and crosstalk characteristics within a circuit, which may advantageously enhance performance by reducing noise and losses. While the coil structure 100 is discussed as a differential terminal device, it is understood that the coil structure 100 can be a single ended inductor, for example, where one terminal (e.g., the second end of the first conductive trace 110) receives a voltage and another terminal (e.g., the second end of the second conductive trace 114) is, e.g., grounded.

The first and fourth conductive traces 110, 126 and the first half of the third conductive trace 122 predominantly overlap and are predominantly aligned with the outer perimeter 302. The second and fifth conductive traces 114, 130 and the second half of the third conductive trace 122 predominantly overlap and are predominantly aligned with the outer perimeter 302. Accordingly, layers 200 of the coil structure 100 efficiently utilizes the footprint of the coil structure 100, which may advantageously maximize magnetic flux since the conductive traces are predominantly stacked at the outer perimeter 302. Accordingly, the inductance of the coil structure 100 may be advantageously maximized for a given footprint (e.g., a given outer perimeter).

FIG. 4 shows a cross-sectional view 400 of the coil structure 100 at a line A-A′ of FIG. 3. FIG. 4 also illustrates a current flow between the conductive layers of the coil structure 100. The first conductive layer 102 is disposed over a substrate 402. The first conductive trace 110 and the second conductive trace 114 are disposed within the first conductive layer 102. The second conductive layer 104 is on a top surface of the first conductive layer 102, and the third conductive layer 106 is on a top surface of the second conductive layer 104. The third conductive trace 122 is disposed within the second conductive layer 104. The fourth conductive trace 126 and the fifth conductive trace 130 are disposed within the third conductive layer 106.

In some embodiments, the substrate 402 can be or comprise silicon (e.g., silicon substrate), gallium, a carbide, a nitride, arsenide, germanium, or the like. The first, second, and third conductive layers 102, 104, 106 can comprise a supporting dielectric material of which the conductive traces are formed on, for example, the conductive layers can comprise one or more of silicon dioxide, silicon nitride, an oxide, aluminum oxide, hafnium oxide, tantalum oxide, a low-k dielectric, or other suitable dielectric. As such, the coil structure 100 can be a chip inductor where the substrate 402 is part of a silicon die with multiple metal layers (metal stack). In other embodiments (not shown in FIG. 4), the first, second, and third conductive layers 102, 104, 106 can be or comprise other dielectric materials such as a ceramic filled polytetrafluoroethylene (PTFE) or a fiberglass dielectric (e.g., FR4), for example, where the conductive layers are layers of a printed circuit board.

Where the coil structure 100 is formed on a substrate 402, the coil structure 100 can be part of an integrated circuit, and the first, second, and third conductive layers 102, 104, 106 are layers of the integrated circuit. The central axis 108 extends perpendicularly through the conductive layers intersecting an upper surface of the substrate 402. The first conductive layer 102 can be closer to the substrate 402 of the integrated circuit than the third conductive layer 106. The first conductive trace 110 and the second conductive trace 114 are arranged at a first height 404 over the substrate 402. The third conductive trace 122 is arranged at a second height 406 over the substrate 402. The fourth conductive trace 126 and the fifth conductive trace 130 are arranged at a third height 408 over the substrate 402. The second height 406 is greater than the first height 404, and the third height 408 is greater than the second height.

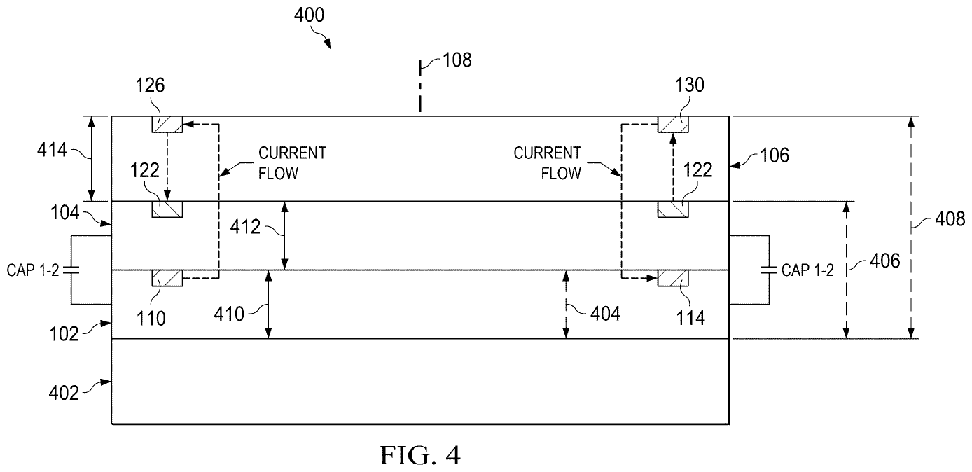

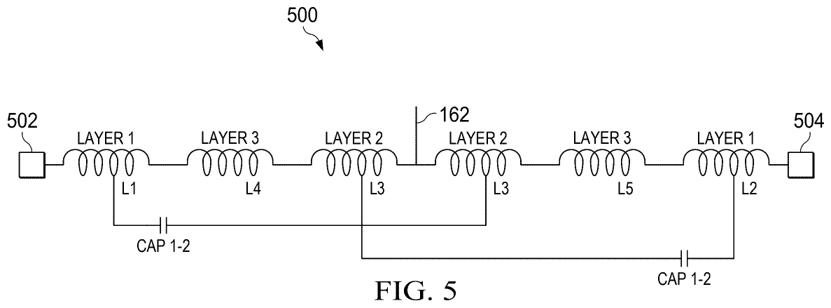

The first conductive layer 102 has a first thickness 410 (e.g., layer thickness or layer height), the second conductive layer 104 has a second thicknesses 412, and the third conductive layer 106 has a third thickness 414. As shown, the first thickness 410 and the second thicknesses 412 are the same, and the third thickness 414 is greater than the first and second thicknesses 410, 412. In some embodiments, the first, second, and third thicknesses 410, 412, 414, can be between 70 and 120 microns. For example, the first and second thicknesses 410, 412 can be 80 microns and the third thickness 414 can be 100 microns. Accordingly, the conductive traces disposed on or within the conductive layers can have different distances from one another. For example, a distance between the first and second conductive traces 110, 114 to the third conductive trace 122 can be less than a distance between the third conductive trace 122 to the fourth and fifth conductive traces 126, 130. A closer distance between conductive traces can increase the coupling between layers, thereby increasing the magnetic flux through the coil structure 100. However, a closer distance between conductive traces can also increase parasitic capacitance, for example, a parasitic capacitance (Cap 1-2) between the first and second conductive layers 102, 104. Cap 1-2 is discussed further in FIG. 5.

The thicknesses shown in FIG. 4 are only an example and it is understood that other thicknesses are possible. In some embodiments, the third thickness 414 can be the same or different relative to the first and second thicknesses 410, 412. In some embodiments, all the thickness of the layers can be different from one another or the same.

A current from a signal provided to the differential terminals of the second end of the first conductive trace 110 and the second end of the second conductive trace 114 that propagates through the coil structure 100 is shown in FIG. 4. As shown, the coil structure 100 is configured to provide the current from the first conductive layer 102 to the third conductive layer 106. The coil structure 100 is further configured to provide the current from the third conductive layer 106 to the second conductive layer 104. Specifically, current flows from the first conductive trace 110 to the fourth conductive trace 126 and from the second conductive trace 114 to the fifth conductive trace 130. Then, the current flows from the fourth conductive trace 126 to the third conductive trace 122 and from the fifth conductive trace 130 to the third conductive trace 122. Thus, the current follows a zig-zag path according to the connecting structures within the coil structure, where the first conductive layer 102 skips connection to the second conductive layer 104, and the first conductive layer 102 is conductively coupled to the second conductive layer 104 through the third conductive layer 106. Accordingly, the coil structure 100 is configured to direct the current to skip layers within the coil structure, which may advantageously minimize parasitic effects of self-capacitance between layers of the coil structure 100 which increases the magnetic flux through the coil structure 100.

FIG. 5 is a circuit diagram 500 of the coil structure 100 of FIGS. 1-4.

The circuit diagram 500 shows inductance values of the conductive traces disposed in the conductive layers. An inductance of the first conductive trace 110 of the first conductive layer 102 (Layer 1) is denoted as L1. An inductance of the second conductive trace 114 of Layer 1 is denoted as L2. An inductance of half of the third conductive trace 122 of the second conductive layer 104 (Layer 2) is denoted as L3. For example, the inductance of the left half of the third conductive trace 122 of FIG. 2B is denoted as L3, and the inductance of the right half of the third conductive trace 122 of FIG. 2B is also denoted as L3. An inductance of the fourth conductive trace 126 of the third conductive layer 106 (Layer 3) is denoted as L4. An inductance of the fifth conductive trace 130 of Layer 3 is denoted as L5. The inductance values (L1-L5) of circuit diagram 500 may be substantially the same. This is because the inductance values relate to half turns of a coil. The first, second, fourth, and fifth conductive traces 110, 114, 126, 130 are approximately half coil turns, as such, L1, L2, L4, and L5 are substantially equivalent values. The third conductive trace 122 is substantially a full coil turn, however, the third conductive trace 122 represents two half coil turns relative to the center tap 162. Accordingly, the circuit diagram 500 illustrates the third conductive trace 122 as two L3 lumped inductors which each represent a half coil turn of the full coil turn of the third conductive trace 122. Thus L1, L2, L3, L4, and L5 are all substantially equivalent values.

The center tap 162 can provide a signal reference point (e.g. ground or a bias voltage), such that the coil structure 100 maintains a balanced output. The center tap 162 can be grounded thereby stabilizing the voltage of the coil structure 100 by providing a path to ground for common-mode noise within the coil structure 100. The center tap 162 can be configured with the advantage of improving impedance match and reducing signal distortion by keeping differential signals at the coil structure 100 input phase aligned and balanced.

The parasitic capacitance between Layer 1 and Layer 2 is shown as Cap 1-2 from the perspective of the differential terminals of the coil structure 100. Cap 1-2 is the dominant parasitic capacitance of the coil structure 100. The first differential terminal 502 is at the second end of the first conductive trace 110 and the second differential terminal 504 is at the second end of the second conductive trace 114. The first differential terminal 502 is from the perspective of the first differential terminal 502, Cap 1-2 shunts the effective inductance L=L1+L4+L3+L3 which represents two coil turns. From the perspective of the second differential terminal 504, Cap 1-2 shunts the effective inductance L=L2+L5+L3+L3 which represents two coil turns. The total inductance Lₜₒₜₐₗ of the inductor is equal to L1+L4+L3+L3+L5+L2 which represents three coil turns. As such, the effective inductance L shunted by Cap 1-2 is less than Lₜₒₜₐₗ. The self-resonant frequency (SRF) of the coil structure 100 can be calculated by equation 1:

$$S R F ≅ \frac{1}{\sqrt{{L}_{t o t a l} * 2 * Cap 1 - 2}} \qquad ( 1 )$$

Compared to an alternative coil structure where the first conductive layer 102 is directly connected to the second conductive layer 104, and the second conductive layer 104 is directly connected to the third conductive layer 106, the SRF of the coil structure 100 occurs at a higher frequency. The SRF of the coil structure 100 is higher because a Cap 1-2 in the alternative coil structure shunts a larger effective inductance (e.g., involving more than two coil turns), reducing the SRF in the alternative coil structure. The layer skipping configuration, where the first conductive layer 102 connects to the third conductive layer 106 (rather than the first conductive layer 102 connecting to the second conductive layer 104), minimizes the effects of parasitic capacitance between layers, thereby maximizing the SRF and quality factor (Q). The coil structure 100 arrangement described in FIGS. 1-5 can result in up to a 50% or better reduction in footprint compared to other arrangements, or a 50% or better increase in inductance for a given footprint.

While coil structure 100 is described as a coil structure, it is appreciated that coil structure 100 can be described as other components. For example, the coil structure 100 can be part of a multi-layer inductor, part of a winding of a transformer, part of a primary or secondary winding of a balun, or part of a differential coil structure. It is also appreciated that the coil structure 100 can be a differential device or in a single ended configuration. That is, the coil structure 100 can be a single ended multi-layer inductor, transformer, or balun where one end of the coil structure 100 is, e.g., grounded.

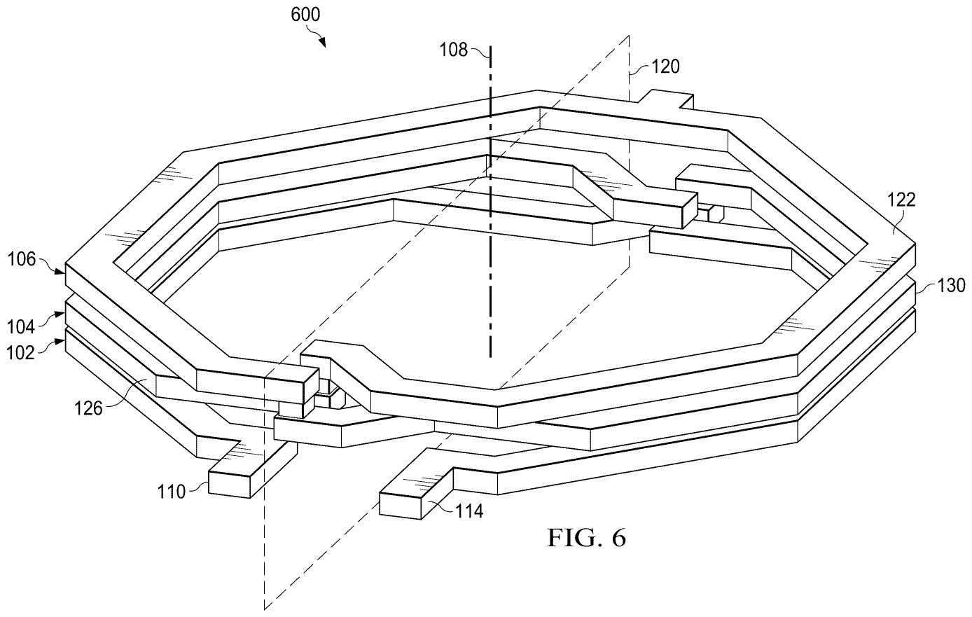

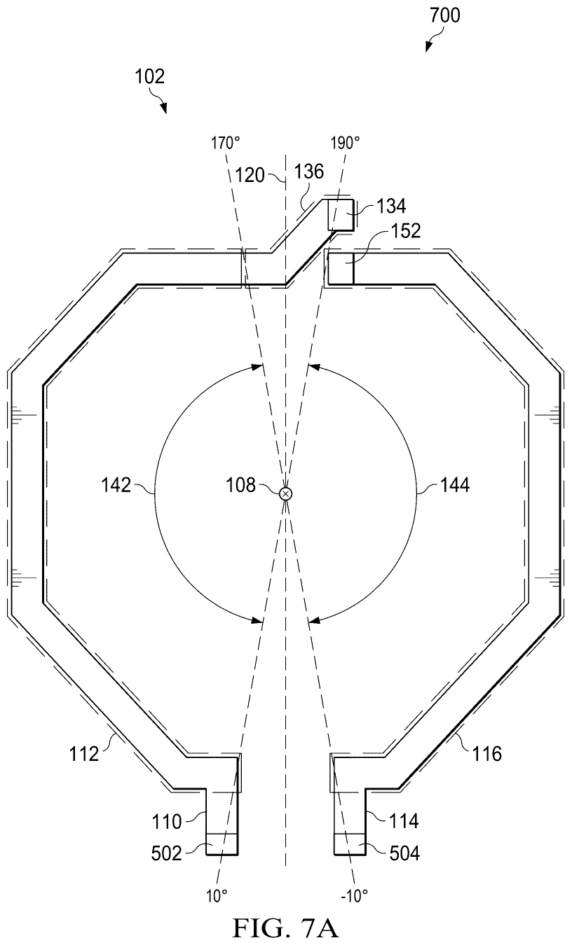

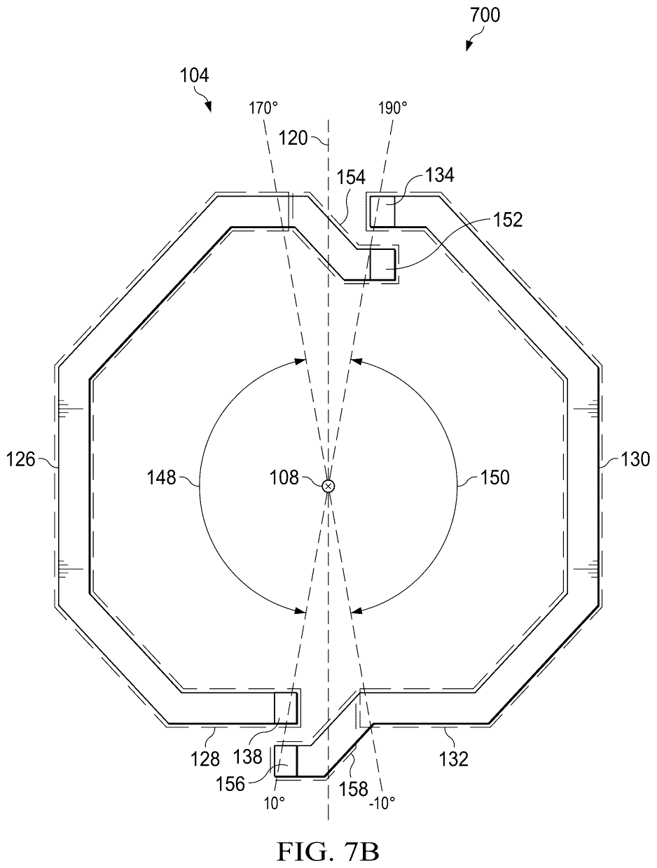

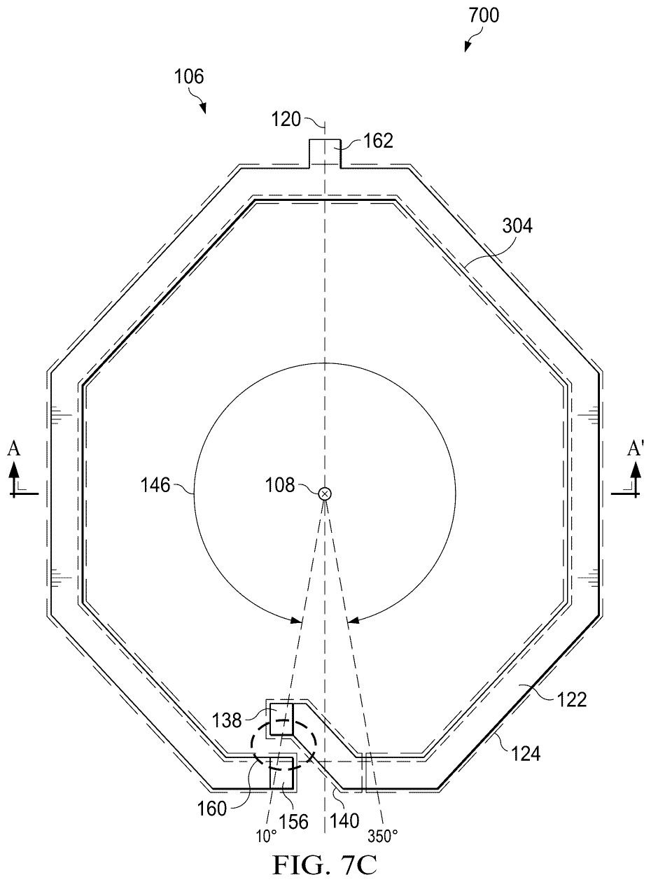

FIG. 6 shows a three-dimensional view of coil structure 600. FIG. 7A shows a two-dimensional view of the first conductive layer 102 of the coil structure 600 FIG. 7B shows a two-dimensional view of the second conductive layer 104 of the coil structure 600. FIG. 7C shows a two-dimensional view of the third conductive layer 106 of the coil structure 600. Accordingly, the first, second, and third conductive layers 102, 104, 106, can be referred to herein as layers 200. FIGS. 6, 7A, 7B, and 7C are now referred to concurrently.

The coil structure 600 shows an alternative arrangement of conductive layers relative to coil structure 100 of FIGS. 1-5. The fourth and fifth conductive traces 126, 130 are disposed in the second conductive layer 104 (in contrast to the third conductive layer 106 of FIGS. 1-5). The third conductive trace 122 is disposed in the third conductive layer 106 (in contrast to the second conductive layer 104 of FIGS. 1-5). Notable features of FIGS. 6, 7A, 7B and 7C that are different from those described in FIGS. 1-5 are described herein. As shown, the first conductive layer 102 is directly connected to the second conductive layer 104, and the second conductive layer 104 is directly connected to the third conductive layer 106. This arrangement of coil structure 600 locates the center tap 162 at the third conductive layer 106 and is advantageous where a device connects to the center tap 162 on the third conductive layer 106 (e.g., rather than the second conductive layer 104). The coil structure 600 maintains the efficient utilization of the coil structure 600 footprint described in FIGS. 1-5 by maximizing magnetic flux since the conductive traces are predominantly stacked at the outer perimeter 302 (as shown in FIG. 3).

The first conductive trace 110 includes a first connecting structure 136 that connects a first conductive loop segment 112 to the fifth conductive loop segment 132. The first connecting structure 136 extends from the first conductive loop segment 112 on the first conductive layer 102 and includes a first via 134 that extends from the first conductive layer 102 to the second conductive layer 104 to couple to the fifth conductive loop segment 132 on the second conductive layer 104. The first via 134 connects a first end of the first conductive trace 110 to a first end of the fifth conductive trace 130.

A second via 138 connects a first end of the fourth conductive trace 126 to a first end of the third conductive trace 122. As such, the third conductive trace 122 includes a second connecting structure 140 that connects the third conductive loop segment 124 to the fourth conductive loop segment 128. Accordingly, the second connecting structure 140 extends from the third conductive loop segment 124 on the third conductive layer 106 and includes the second via 138 that extends from the third conductive layer 106 to the second conductive layer 104 to meet the fourth conductive loop segment 128 on the second conductive layer 104.

A third via 152 connects a first end of the second conductive trace 114 to a second end of the fourth conductive trace 126. As such, the fourth conductive trace 126 includes a third connecting structure 154 that connects the fourth conductive loop segment 128 to the second conductive loop segment 116. Accordingly, the third connecting structure 154 extends from the fourth conductive loop segment 128 on the second conductive layer 104 and includes the third via 152 that extends from the second conductive layer 104 to the first conductive layer 102 to meet the second conductive loop segment 116 on the first conductive layer 102.

A fourth via 156 connects a second end of the fifth conductive trace 130 to a second end of the third conductive trace 122. As such, the fifth conductive trace 130 includes a fourth connecting structure 158 that connects the fifth conductive loop segment 132 to the third conductive loop segment 124. Accordingly, the fourth connecting structure 158 extends from the fifth conductive loop segment 132 on the second conductive layer 104 and includes the fourth via 156 that extends from the second conductive layer 104 to the third conductive layer 106 to meet the third conductive loop segment 124 on the third conductive layer 106.

As shown in FIG. 7C, from a top view, an inner perimeter 304 is defined by a composite of the first, second, third, fourth, and fifth conductive traces 110, 114, 122, 126, 130 that is coil shaped (e.g., see also FIG. 3). At a first end of the inner perimeter, the third, fourth, and fifth conductive traces 122, 126, 130 extend within the inner perimeter 304. At a second end of the inner perimeter 304 that is opposite the first end of the inner perimeter, the first, second, third, and fourth conductive traces 110, 114, 122, 126 traces extend within the inner perimeter 304.

At regions of the inner perimeter other than the first and second ends of the inner perimeter, the first and fourth conductive traces 110, 126 and a first half of the third conductive trace 122 are aligned and extend from the inner perimeter 304 to an outer perimeter (e.g., outer perimeter 302 of FIG. 3). Also, the second and fifth conductive traces 114, 130 and a second half of the third conductive trace are aligned and extend from the inner perimeter 304 to an outer perimeter (e.g., outer perimeter 302 of FIG. 3.)

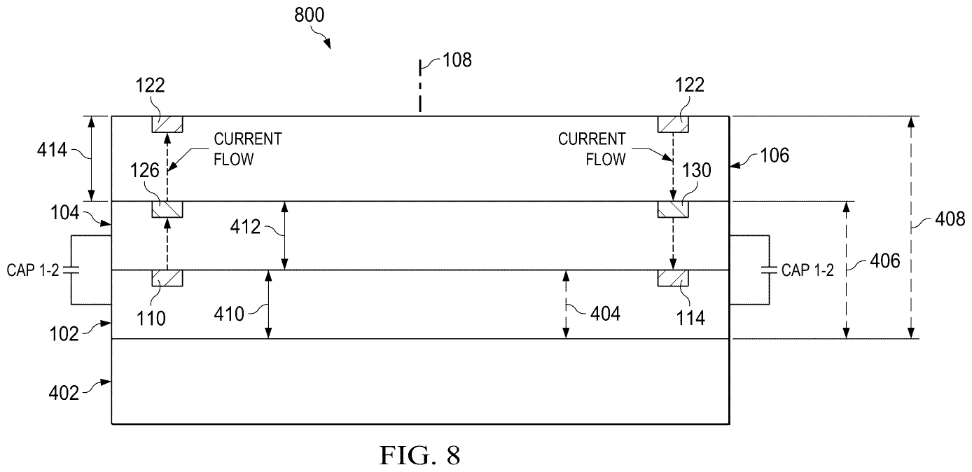

FIG. 8 shows a cross-sectional view 800 of the coil structure 600 at a line A-A′ of FIG. 7B (e.g., shown on the third conductive layer 106, analogous to the line A-A′ of FIG. 3 that also intersects the layers 700). FIG. 8 also illustrates a current flow between the conductive layers of the coil structure 600. FIG. 8 shows alternative features relative to FIG. 4, where the fourth and fifth conductive traces 126, 130 are on the second conductive layer 104 (rather than the third conductive layer 106) and the third conductive trace is on the third conductive layer 106 (rather than the second conductive layer 104). Notable features of FIG. 8 that are different from those described in FIG. 4 are described herein related to the current flow.

The current from a signal provided to the differential terminals of the second end of the first conductive trace 110 and the second end of the second conductive trace 114 that propagates through the coil structure 600 is shown in FIG. 8. The coil structure 600 is configured to provide the current from the first conductive layer 102 to the second conductive layer 104, and from the second conductive layer 104 to the third conductive layer 106. Specifically, current flows from the first conductive trace 110 on the first conductive layer 102 to the fourth conductive trace 126 on the second conductive layer 104 and from the second conductive trace 114 on the first conductive layer 102 to the fifth conductive trace 130 on the second conductive layer 104. Then the current flows from the fourth conductive trace 126 to the third conductive trace 122 on the third conductive layer 106 and from the fifth conductive trace 130 to the third conductive trace 122.

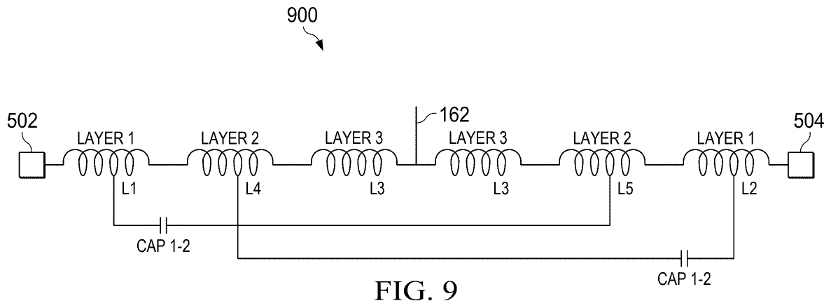

FIG. 9 is a circuit diagram 900 of the coil structure 100 of FIGS. 6-8. Several aspects of FIG. 9 corresponds to the description provided in FIG. 5. Notable features of FIG. 9 that are different from those described in FIG. 5 are described herein.

A parasitic capacitance (Cap 1-2) between Layer 1 and Layer 2 is shown from the perspective of the differential terminals of the coil structure 600. Cap 1-2 is the dominant parasitic capacitance of the coil structure 600. From the perspective of a first differential terminal 502, Cap 1-2 shunts the effective inductance L=L1+L4+L3+L3+L5 which represents two and a half coil turns. From the perspective of the second differential terminal 504, Cap 1-2 shunts the effective inductance L=L2+L5+L3+L3+L4 which represents two and a half coil turns. The total inductance Lₜₒₜₐₗ of the inductor is equal to L1+L4+L3+L3+L5+L2 which represents three coil turns. As such, the effective inductance L shunted by Cap 1-2 is less than Lₜₒₜₐₗ (but more than Lₜₒₜₐₗ of FIG. 5). The SRF of the coil structure 600 can be calculated by equation 1 (previously presented).

Relative to the SRF of FIG. 5, the SRF of coil structure 600 of FIG. 9 is lower since CAP 1-2 of FIG. 9 is shunting a larger effective inductance (from two and a half coil turns) relative to shunting an lower effective inductance (from two turns) of FIG. 5. However, coil structure 600 is configured with the center tap 162 located on the third conductive layer 106 rather than the second conductive layer (as shown in the coil structure 100 of FIGS. 1-6). Accordingly, coil structure 600 can provide the benefit of locating the center tap 162 on a favorable layer while maximizing the magnetic flux through the coil structure 600 by predominantly stacking the conductive traces at an outer perimeter of the coil structure 600 footprint.

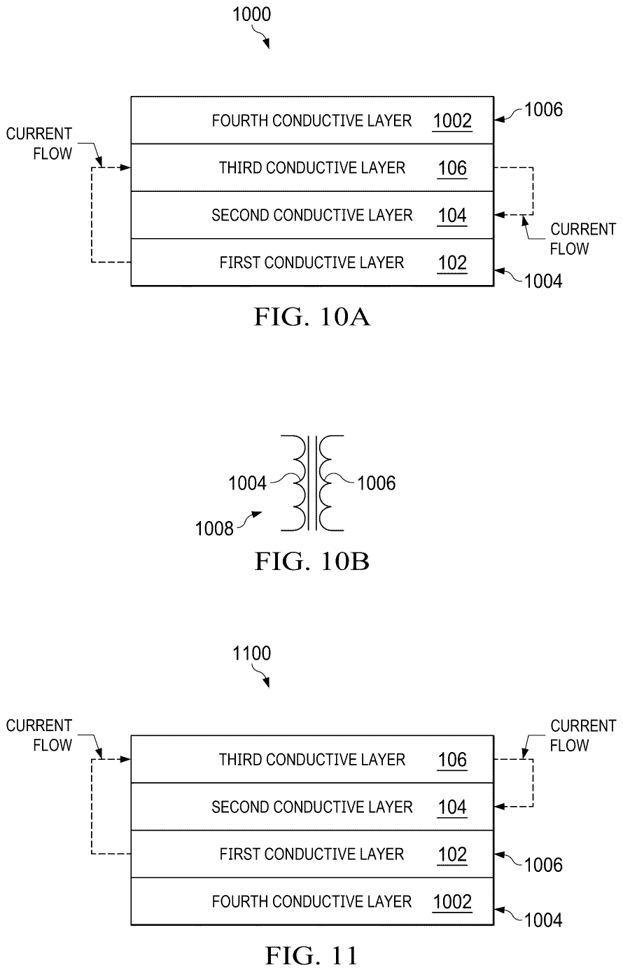

FIG. 10A shows a cross-sectional view 1000 of a multi-layer coil structure. FIG. 10B shows a structural representation of the multi-layer coil structure of FIG. 10A. FIG. 11 shows a cross-sectional view 1100 of a multi-layer coil structure. FIG. 10A shows a layer arrangement where the coil structure 100 of FIGS. 1-3 is configured for a transformer or a balun (shown in FIG. 10B). FIGS. 10A and 11 show the coil structure with a first, second, and third conductive layers 102, 104, 106, where the second conductive layer 104 is disposed between the first conductive layer 102 and the third conductive layer 106. The current flows from the first conductive layer 102 to the third conductive layer 106, thereby skipping the second conductive layer 104. The current subsequently flows from the third conductive layer 106 to the second conductive layer 104. The coil structure 100 can be the primary side 1004 or the secondary side 1006 (e.g., windings) of a balun or transformer with the fourth conductive layer including part (e.g., the entirety) of the winding of the other side of the transformer or balun. In some embodiments, the other side of the transformer or balun includes more than one turn in one or more conductive layers. In some embodiments, the winding of the other side of the transformer or balun includes a only single turn implemented in the fourth conductive layer 1002.

FIGS. 10A and 10B show the coil structure 100 as the primary side 1004, where the primary side 1004 has connection terminals on the first conductive layer 102 and the secondary side 1006 is another structure on a fourth conductive layer 1002 that is disposed over the third conductive layer 106. Thus the third conductive layer 106 is disposed between the second and fourth conductive layers 104, 1002. Accordingly, the coil structure is an inductive structure that is a primary winding where at least a portion of a secondary winding is disposed on the fourth conductive layer 1002. FIG. 10B shows a transformer 1008 depicting the primary side 1004 and the secondary side 1006 windings.

FIG. 11 shows the coil structure 100 as the secondary side 1006, where the secondary side 1006 has connection terminals on the first conductive layer 102 and the primary side 1004 is another structure on the fourth conductive layer 1002 that is disposed under the first conductive layer 102. Thus the first conductive layer 102 is disposed between the second and fourth conductive layers 104, 1002. Accordingly, the coil structure is an inductive structure that is a secondary winding where a portion of the primary winding is disposed on the fourth conductive layer 1002.

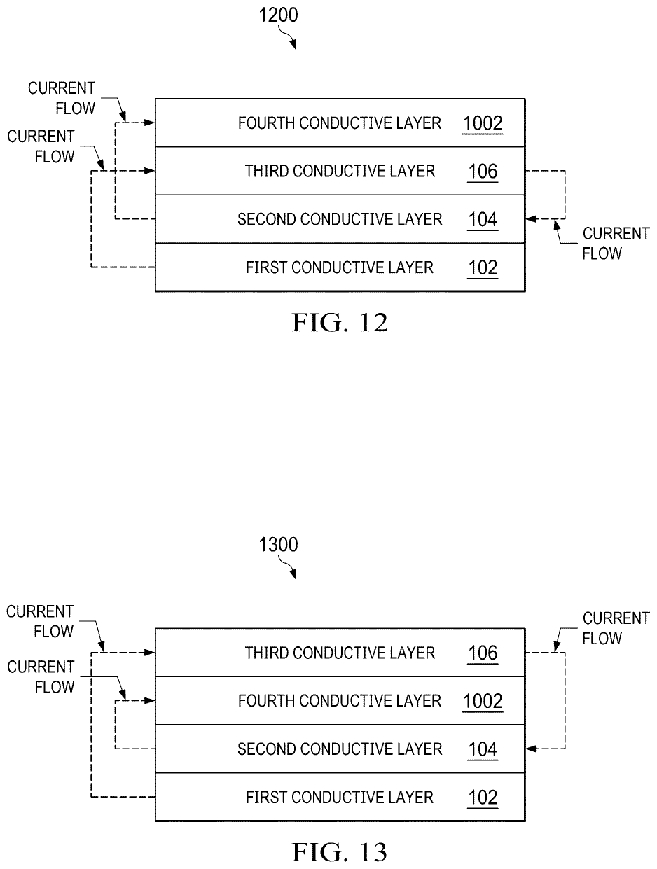

FIG. 12 shows a cross-sectional view 1200 of a multi-layer coil structure. The multi-layer coil structure is shown with four layers. The multi-layer coil structure includes a second conductive layer 104 between a first conductive layer 102 and a third conductive layer 106, where the second conductive layer 104 is disposed over the first conductive layer 102. The multi-layer coil structure further includes a fourth conductive layer 1002 disposed over the third conductive layer 106 where the third conductive layer 106 is disposed between the fourth conductive layer 1002 and the second conductive layer 104.

The first conductive layer 102 is directly connected to the third conductive layer 106 (skipping direct connection to the second conductive layer 104). The third conductive layer 106 is directly connected to the second conductive layer 104. The second conductive layer 104 also has a direct connection to the fourth conductive layer 1002. Accordingly, the current flows from the first conductive layer 102 to the third conductive layer 106, from the third conductive layer 106 to the second conductive layer 104, and from the second conductive layer 104 to the fourth conductive layer 1002.

The first, second, and third conductive layers 102, 104, 106 include at least a first, second, third, fourth, and fifth conductive traces (not shown) with associated conductive loop segments and connecting structures. (e.g., analogous to FIGS. 1-5). For example, the first, second, and third conductive layers 102, 104, 106 can include a first, second, third, fourth, and fifth conductive loop segments and at least a first and second connecting structure. The fourth conductive layer 1002 includes a sixth conductive loop segment (not shown) and a third connecting structure connecting the sixth conductive loop segment to a conductive loop segment of the second conductive layer 104.

FIG. 13 shows a cross-sectional view 1300 of a multi-layer coil structure. The multi-layer coil structure is shown with four layers. The multi-layer coil structure includes a second conductive layer 104 between a first conductive layer 102 and a third conductive layer 106, where the second conductive layer 104 is disposed over the first conductive layer 102. The multi-layer coil structure further includes a fourth conductive layer 1002 disposed over the second conductive layer 104 where the fourth conductive layer 1002 is disposed between the third conductive layer 106 and the second conductive layer 104.

The first conductive layer 102 is directly connected to the third conductive layer 106 (skipping direct connection to the second and fourth conductive layers 104, 1002). The third conductive layer 106 is directly connected to the second conductive layer 104 (skipping direct connection to the fourth conductive layer 1002). The second conductive layer 104 is directly connected to the fourth conductive layer 1002. Accordingly, the current flows from the first conductive layer 102 to the third conductive layer 106, from the third conductive layer 106 to the second conductive layer 104, and from the second conductive layer 104 to the fourth conductive layer 1002.

The first, second, and third conductive layers 102, 104, 106 include at least a first, second, third, fourth, and fifth conductive traces (not shown) with associated conductive loop segments and connecting structures. (e.g., analogous to FIGS. 1-5). For example, the first, second, and third conductive layers 102, 104, 106 can include a first, second, third, fourth, and fifth conductive loop segments and at least a first and second connecting structure. The fourth conductive layer 1002 includes a sixth conductive loop segment (not shown) and a third connecting structure connecting the sixth conductive loop segment to a conductive loop segment of the second conductive layer 104.

Example embodiments of the present disclosure are summarized here. Other embodiments can also be understood from the entirety of the specification and the claims filed herein.

Example 1. A coil structure including: a first conductive layer including a first conductive loop segment and a second conductive loop segment that collectively substantially surround a central axis that is orthogonal to the first conductive layer, the first and second conductive loop segments being arranged symmetrically on opposite sides of a plane that includes the central axis; a second conductive layer, the second conductive layer including a third conductive loop segment that substantially surrounds the central axis when viewed along the central axis; a third conductive layer, the third conductive layer including a fourth conductive loop segment and a fifth conductive loop segment that collectively substantially surround the central axis when viewed along the central axis, the fourth and fifth conductive loop segments being arranged symmetrically on opposite sides of the plane, where the second conductive layer is disposed between the first and third conductive layers; a first connecting structure connecting the first conductive loop segment of the first conductive layer to the fifth conductive loop segment of the third conductive layer; and a second connecting structure connecting the fourth conductive loop segment of the third conductive layer to the third conductive loop segment of the second conductive layer.

Example 2. The coil structure of example 1, further including: a fourth conductive layer including a sixth conductive loop segment, where the third conductive layer is disposed between the second conductive layer and the fourth conductive layer; and a third connecting structure connecting the sixth conductive loop segment to the third conductive loop segment of the second conductive layer.

Example 3. The coil structure of one of examples 1 or 2, further including: a fourth conductive layer disposed between the second conductive layer and the third conductive layer, the fourth conductive layer including a sixth conductive loop segment; and a third connecting structure connecting the sixth conductive loop segment to the third conductive loop segment of the second conductive layer.

Example 4. The coil structure of one of examples 1 to 3, where the first connecting structure includes: a first connecting segment arranged in the first conductive layer and extending at an acute angle from a first end of the first conductive loop segment, the first connecting segment extending across the plane; and a via extending between the first conductive layer and the third conductive layer and coupling the first connecting segment to the fifth conductive loop segment.

Example 5. The coil structure of one of examples 1 to 4, where the first connecting segment is asymmetric about the plane.

Example 6. The coil structure of one of examples 1 to 5, where, when viewed from the central axis and in a polar coordinate system, the first conductive loop segment extends continuously over a first angle ranging from approximately a first value of −10 degrees to 10 degrees to a second value of approximately 170 degrees to 190 degrees; and the second conductive loop segment extends continuously over a second angle ranging from a third value of approximately 170 degrees and 190 degrees to a fourth value of approximately-10 degrees to 10 degrees.

Example 7. The coil structure of one of examples 1 to 6, where, when viewed from the central axis and in the polar coordinate system, the third conductive loop segment extends continuously over a third angle ranging from approximately a fifth value of 1 degree to 20 degrees to a sixth value of approximately 340 degrees to 359 degrees.

Example 8. The coil structure of one of examples 1 to 7, where, when viewed from the central axis and in the polar coordinate system, the fourth conductive loop segment extends continuously over a fourth angle ranging from approximately a seventh value of −10 degrees to 10 degrees to an eighth value of approximately 170 degrees to 190 degrees; and the fifth conductive loop segment extends continuously over a fifth angle ranging from a ninth value of approximately 170 degrees and 190 degrees to a tenth value of approximately-10 degrees to 10 degrees.

Example 9. The coil structure of one of examples 1 to 8, where the coil structure is part of a winding of a transformer.

Example 10. The coil structure of one of examples 1 to 9, where the coil structure is part of a multi-layer inductor.

Example 11. The coil structure of one of examples 1 to 10, where the first, second, and third conductive layers are metal layers of an integrated circuit.

Example 12. The coil structure of one of examples 1 to 11, where the second conductive layer is disposed over the first conductive layer, and where the third conductive layer is disposed over the second conductive layer so that the first conductive layer is closer to a silicon substrate of the integrated circuit than the third conductive layer.

Example 13. The coil structure of one of examples 1 to 12, where the first, second, and third conductive layers include a same metal material.

Example 14. The coil structure of one of examples 1 to 13, where the first, second, and third conductive layers are layers of a printed circuit board.

Example 15. The coil structure of one of examples 1 to 14, where the coil structure is part of a secondary winding of a balun.

Example 16. The coil structure of one of examples 1 to 15, where the coil structure is a differential coil structure.

Example 17. An inductive structure including: a first conductive layer including a first conductive trace and a second conductive trace; a second conductive layer disposed, the second conductive layer including a third conductive trace; a third conductive layer disposed, the third conductive layer including a fourth conductive trace and a fifth conductive trace, where the second conductive layer is disposed between the first and third conductive layers; a first via connecting a first end of the first conductive trace to a first end of the fifth conductive trace; a second via connecting a first end of the fourth conductive trace to a first end of the third conductive trace; a third via connecting a first end of the second conductive trace to a second end of the fourth conductive trace; and a fourth via connecting a second end of the fifth conductive trace to a second end of the third conductive trace.

Example 18. The inductive structure of example 17, where the second and fifth conductive traces substantially overlap, and where the first and fourth conductive traces substantially overlap.

Example 19. The inductive structure of one of examples 17 or 18, where the third conductive trace is a loop, with a first half and a second half, where the first half of the third conductive trace substantially overlaps with the fourth conductive trace and the first conductive trace, and where the second half of the third conductive trace substantially overlaps with the fifth conductive trace and the second conductive trace.

Example 20. The inductive structure of one of examples 17 to 19, where the third conductive trace is a loop with an open end, where at a location opposite of the open end of the third conductive trace: the first conductive trace extends into an interior of the third conductive trace and meets the first via adjacent to an interior edge of the third conductive trace; and the fourth conductive trace extends into the interior of the third conductive trace and overlaps the first conductive trace to meet the second via, where the third via is between the first via and the open end of the third conductive trace.

Example 21. The inductive structure of one of examples 17 to 20, where the third conductive trace is a loop with an open end, where at the open end: the second end of the third conductive trace extends to an interior of the third conductive trace, where the second end of the third conductive trace is aligned adjacent to an inner edge of the first end of the third conductive trace.

Example 22. The inductive structure of one of examples 17 to 21, where adjacent to the open end of the third conductive trace, the fifth conductive trace substantially overlaps the third conductive trace to meet the fourth via.

Example 23. The inductive structure of one of examples 17 to 22, where the second via is disposed between the fourth via and the third via.

Example 24. The inductive structure of one of examples 17 to 23, where the third conductive trace is substantially octagonal in shape.

Example 25. The inductive structure of one of examples 17 to 24, where the first and second conductive layers include a first metal and the third conductive layer includes a second metal that is different from the first metal.

Example 26. The inductive structure of one of examples 17 to 25, where the first and second conductive layers are copper and the third conductive layer is aluminum.

Example 27. The inductive structure of one of examples 17 to 26, where a first thickness of the first conductive layer is the same as a second thickness of the second conductive layer, and a third thickness of the third conductive layer is different from the first and second thicknesses.

Example 28. The inductive structure of one of examples 17 to 27, where: the inductive structure is a primary winding of a balun, where a portion of a secondary winding of the balun is disposed on a fourth conductive layer, and where the third conductive layer is disposed between the second and fourth conductive layers; or the inductive structure is the secondary winding of the balun, where a portion of the primary winding of the balun is disposed on the fourth conductive layer, and where the first conductive layer is disposed between the second and fourth conductive layers.

Example 29. The inductive structure of one of examples 17 to 28, where the inductive structure is a primary winding or a secondary winding of a transformer.

Example 30. An integrated circuit, including: a substrate, where an inductor axis perpendicularly intersects an upper surface of the substrate; a first metal trace arranged at a first height over the substrate and extending axially about a first side of the inductor axis; a second metal trace arranged at the first height over the substrate and extending axially about a second side of the inductor axis, the second side of the inductor axis opposite the first side; a third metal trace arranged at a second height over the substrate, the third metal trace extending axially about the first and second sides of the inductor axis directly over at least a portion of the first and second metal traces; a fourth metal trace arranged at a third height over the substrate, the fourth metal trace extending axially about the first side of the inductor axis and extending directly over a first portion of the third metal trace; a fifth metal trace arranged at the third height over the substrate, the fifth metal trace extending axially about the second side of the inductor axis and extending directly over a second portion of the third metal trace; a first via connecting a first end of the first metal trace to a first end of the fifth metal trace; a second via connecting a first end of the fourth metal trace to a first end of the third metal trace; a third via connecting a first end of the second metal trace to a second end of the fourth metal trace; and a fourth via connecting a second end of the fifth metal trace to a second end of the third metal trace.

Example 31. The integrated circuit of example 30, where the second height is greater than the first height, and the third height is greater than the second height.

Example 32. The integrated circuit of one of examples 30 or 31, where, at an axial location of the third metal trace that is opposite of the second and fourth vias, the first via separates the third via from an inner edge of the third metal trace.

Example 33. The integrated circuit of one of examples 30 to 32, where: an inner edge of the third metal trace defines an inner boundary; the first and fifth metal traces extend into the inner boundary to contact the first via; and the second and fourth metal traces extend into the inner boundary to contact the second via, where the first metal trace overlaps the fourth metal trace inside the inner boundary.

Example 34. The integrated circuit of one of examples 30 to 33, where: an inner edge of the third metal trace defines an inner boundary; the third and fourth metal traces extend into the inner boundary to contact the third via; and the fifth metal trace extends into the inner boundary to contact the fourth via.

Example 35. The integrated circuit of one of examples 30 to 34, where, at an axial location of the third metal trace that is opposite of the first and third vias, the fourth via separates the second via from an inner edge of the third metal trace.

Example 36. A coil structure including: a first conductive layer including a first conductive trace and a second conductive trace; a second conductive layer disposed over the first conductive layer, the second conductive layer including a third conductive trace and a fourth conductive trace; a third conductive layer disposed over the second conductive layer, the third conductive layer including a fifth conductive trace; a first via connecting a first end of the first conductive trace to a first end of the fifth conductive trace; a second via connecting a first end of the third conductive trace to a first end of the fourth conductive trace; a third via connecting a first end of the second conductive trace to a second end of the fourth conductive trace; and a fourth via connecting a second end of the fifth conductive trace to a second end of the third conductive trace.

Example 37. The coil structure of example 36, where, from a top view, an inner perimeter is defined by a composite of the first, second, third, fourth, and fifth conductive traces, that is coil shaped, where: at a first end of the inner perimeter, the third, fourth, and fifth conductive traces extend within the inner perimeter; and at a second end of the inner perimeter opposite the first end of the inner perimeter, the first, second, third, and fourth conductive traces extend within the inner perimeter.

Example 38. The coil structure of one of examples 36 or 37, where, at regions of the inner perimeter other than the first and second ends of the inner perimeter: the first conductive trace, the fourth conductive trace, and a first half of the third conductive trace are aligned and extend from the inner perimeter to an outer perimeter; and the second conductive trace, the fifth conductive trace, and a second half of the third conductive trace are aligned and extend from the inner perimeter to the outer perimeter.

The above description of illustrated examples, implementations, aspects, etc., of the subject description, including what is described in the Abstract, is not to be exhaustive or to limit the described aspects to the precise forms described. While specific examples, implementations, aspects, etc., are described herein for illustrative purposes, various modifications are possible that are considered within the scope of such examples, implementations, aspects, etc., as those skilled in the relevant art can recognize.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” may be understood as one or more circuits that are: (i) incorporated in/over a semiconductor substrate; (ii) incorporated in a single semiconductor package; (iii) incorporated into the same module; and/or (iv) incorporated in/on the same printed circuit board.

Unless otherwise stated, “about,” “approximately,” or “substantially” preceding a value means+/−10 percent of the stated value, or, if the value is zero, a reasonable range of values around zero. Modifications are possible in the described examples, and other implementations are possible, within the scope of the claims.

What is claimed is:

1. A coil structure comprising:
a first conductive layer comprising a first conductive loop segment and a second conductive loop segment that collectively substantially surround a central axis that is orthogonal to the first conductive layer, the first and second conductive loop segments being arranged symmetrically on opposite sides of a plane that includes the central axis;
a second conductive layer, the second conductive layer comprising a third conductive loop segment that substantially surrounds the central axis when viewed along the central axis;
a third conductive layer, the third conductive layer comprising a fourth conductive loop segment and a fifth conductive loop segment that collectively substantially surround the central axis when viewed along the central axis, the fourth and fifth conductive loop segments being arranged symmetrically on opposite sides of the plane, wherein the second conductive layer is disposed between the first and third conductive layers;
a first connecting structure connecting the first conductive loop segment of the first conductive layer to the fifth conductive loop segment of the third conductive layer; and
a second connecting structure connecting the fourth conductive loop segment of the third conductive layer to the third conductive loop segment of the second conductive layer.

2. The coil structure of claim 1, further comprising:
a fourth conductive layer including a sixth conductive loop segment, wherein the third conductive layer is disposed between the second conductive layer and the fourth conductive layer; and
a third connecting structure connecting the sixth conductive loop segment to the third conductive loop segment of the second conductive layer.

3. The coil structure of claim 1, further comprising:
a fourth conductive layer disposed between the second conductive layer and the third conductive layer, the fourth conductive layer including a sixth conductive loop segment; and
a third connecting structure connecting the sixth conductive loop segment to the third conductive loop segment of the second conductive layer.

4. The coil structure of claim 1, wherein the first connecting structure comprises:
a first connecting segment arranged in the first conductive layer and extending at an acute angle from a first end of the first conductive loop segment, the first connecting segment extending across the plane; and
a via extending between the first conductive layer and the third conductive layer and coupling the first connecting segment to the fifth conductive loop segment.

5. The coil structure of claim 4, wherein the first connecting segment is asymmetric about the plane.

6. The coil structure of claim 1, wherein, when viewed from the central axis and in a polar coordinate system, the first conductive loop segment extends continuously over a first angle ranging from approximately a first value of −10 degrees to 10 degrees to a second value of approximately 170 degrees to 190 degrees; and the second conductive loop segment extends continuously over a second angle ranging from a third value of approximately 170 degrees and 190 degrees to a fourth value of approximately −10 degrees to 10 degrees.

7. The coil structure of claim 6, wherein, when viewed from the central axis and in the polar coordinate system, the third conductive loop segment extends continuously over a third angle ranging from approximately a fifth value of 1 degree to 20 degrees to a sixth value of approximately 340 degrees to 359 degrees.

8. The coil structure of claim 7, wherein, when viewed from the central axis and in the polar coordinate system, the fourth conductive loop segment extends continuously over a fourth angle ranging from approximately a seventh value of −10 degrees to 10 degrees to an eighth value of approximately 170 degrees to 190 degrees; and the fifth conductive loop segment extends continuously over a fifth angle ranging from a ninth value of approximately 170 degrees and 190 degrees to a tenth value of approximately −10 degrees to 10 degrees.

9. The coil structure of claim 1, wherein the coil structure is part of a winding of a transformer.

10. The coil structure of claim 1, wherein the coil structure is part of a multi-layer inductor.

11. The coil structure of claim 1, wherein the first, second, and third conductive layers are metal layers of an integrated circuit.

12. The coil structure of claim 11, wherein the second conductive layer is disposed over the first conductive layer, and wherein the third conductive layer is disposed over the second conductive layer so that the first conductive layer is closer to a silicon substrate of the integrated circuit than the third conductive layer.

13. The coil structure of claim 11, wherein the first, second, and third conductive layers comprise a same metal material.

14. The coil structure of claim 1, wherein the first, second, and third conductive layers are layers of a printed circuit board.

15. The coil structure of claim 1, wherein the coil structure is part of a secondary winding of a balun.

16. The coil structure of claim 1, wherein the coil structure is a differential coil structure.

17. An integrated circuit, comprising:
a substrate, wherein an inductor axis perpendicularly intersects an upper surface of the substrate;
a first metal trace arranged at a first height over the substrate and extending axially about a first side of the inductor axis;
a second metal trace arranged at the first height over the substrate and extending axially about a second side of the inductor axis, the second side of the inductor axis opposite the first side;
a third metal trace arranged at a second height over the substrate, the third metal trace extending axially about the first and second sides of the inductor axis directly over at least a portion of the first and second metal traces;
a fourth metal trace arranged at a third height over the substrate, the fourth metal trace extending axially about the first side of the inductor axis and extending directly over a first portion of the third metal trace;
a fifth metal trace arranged at the third height over the substrate, the fifth metal trace extending axially about the second side of the inductor axis and extending directly over a second portion of the third metal trace;
a first via connecting a first end of the first metal trace to a first end of the fifth metal trace;
a second via connecting a first end of the fourth metal trace to a first end of the third metal trace;
a third via connecting a first end of the second metal trace to a second end of the fourth metal trace; and
a fourth via connecting a second end of the fifth metal trace to a second end of the third metal trace.

18. The integrated circuit of claim 17, wherein the second height is greater than the first height, and the third height is greater than the second height.

19. The integrated circuit of claim 17, wherein, at an axial location of the third metal trace that is opposite of the second and fourth vias, the first via separates the third via from an inner edge of the third metal trace.

20. The integrated circuit of claim 17, wherein:
an inner edge of the third metal trace defines an inner boundary;
the first and fifth metal traces extend into the inner boundary to contact the first via; and
the second and fourth metal traces extend into the inner boundary to contact the second via, wherein the first metal trace overlaps the fourth metal trace inside the inner boundary.

21. The integrated circuit of claim 17, wherein:
an inner edge of the third metal trace defines an inner boundary;
the third and fourth metal traces extend into the inner boundary to contact the third via; and
the fifth metal trace extends into the inner boundary to contact the fourth via.

22. The integrated circuit of claim 17, wherein, at an axial location of the third metal trace that is opposite of the first and third vias, the fourth via separates the second via from an inner edge of the third metal trace.
